(19) United States
(12) Patent Application Publication
(10) Pub. No.: US 2026/0251101 A1
(43) Pub. Date: Aug. 27, 2026

(54) METHOD FOR OPERATING A DRIVE DEVICE FOR A MOTOR VEHICLE AND CORRESPONDING DRIVE DEVICE

(71) Applicant: AUDI Aktiengesellschaft, Ingolstadt (DE)

(72) Inventors: Thomas RIEGER, Wettstetten (DE); Mario BECKER, Heinsheim (DE); Matthias DECK, Zaberfeld (DE); Joachim STEFAN, Hofstetten (DE)

(73) Assignee: AUDI Aktiengesellschaft, Ingolstadt (DE)

(21) Appl. No.: 19/162,263

(22) PCT Filed: Mar. 1, 2024
(86) PCT No.: PCT/EP2024/055375

§ 371 Date: Sep. 4, 2025

(30) Foreign Application Priority Data
Mar. 7, 2023 (DE) 10 2023 202 020.3

(51) Int. Cl. F02D 41/22; F02D 41/14

(52) U.S. Cl. CPC F02D 41/22; F02D 41/1461; F02D 2041/1468

(57) ABSTRACT

A method for operating a drive device for a motor vehicle, the drive device has an exhaust-gas-generating drive unit, and by an exhaust gas probe an exhaust gas value describing a composition of the exhaust gas is determined, and for a plurality of systems of the drive device a state value describing the state of the respective system is determined, in each case as part of a system diagnosis. For each of the plurality of systems, it is defined in at least one system defect data set whether a system defect of the respective system affects the exhaust gas value. If the exhaust gas value departs from an exhaust gas range, the system defect data sets are put on a checklist of system defect data sets to be checked, and then, those system defect data sets for which the exhaust gas value is not affected are removed from the checklist.

### FIELD

The invention relates to a method for operating a drive device for a motor vehicle, wherein the drive device has an exhaust-gas-generating drive unit, and by means of an exhaust gas probe an exhaust gas value describing a composition of the exhaust gas is determined, and for a plurality of systems of the drive device a state value describing the state of the respective system is determined, in each case as part of a system diagnosis. The invention further relates to a drive device for a motor vehicle.

### BACKGROUND

DE 10 2021 003 415 A1 is known from the prior art, for example. The invention relates to a control device for monitoring an emission behavior of a machine, wherein the monitoring is carried out based on a first emission influence of a component of the machine. The control device is designed and set up to carry out the following steps: determining a first defect measure of a first component of the machine, determining a first emission influence based on the determined first defect measure and monitoring the emission behavior of the machine based on the first emission influence.

### SUMMARY

It is an object of the invention to propose a method for operating a drive device which has advantages over the prior art, in particular to detect a system defect of one of the systems of the drive device with high reliability even if the system diagnosis of the respective system does not indicate such a defect.

This is achieved according to the invention with a method for operating a drive device for a motor vehicle. In this case, it is provided that for each of the plurality of systems, it is defined in at least one system defect data set whether a system defect of the respective system affects the exhaust gas value, wherein if the exhaust gas value departs from an exhaust gas range, the system defect data sets of the systems are first put on a checklist of system defect data sets to be checked, and then, those system defect data sets for which it is defined that the exhaust gas value is not affected are removed from the checklist, wherein for the system defect data sets remaining on the checklist, a device diagnosis is carried out to detect the system defect of the respective system based on the state value.

Advantageous embodiments with expedient developments of the invention are specified in the disclosure. It is pointed out that the exemplary embodiments explained in the description are not limiting; rather, any variations of the features disclosed in the description, the claims and the figures can be implemented.

The drive device is used to drive the motor vehicle and thus insofar to provide a drive torque that is provided for driving the motor vehicle. The drive device is preferably part of the motor vehicle, but can of course also be separate from it. To provide the drive torque, the drive device has the drive unit, which is preferably designed as an internal combustion machine. Fuel and fresh gas are at least temporarily supplied to the drive unit during operation of the drive device, wherein the fresh gas contains fresh air at least temporarily. In addition, the fresh gas can have exhaust gas, provided that exhaust gas recirculation is implemented in which the exhaust gas generated by the drive unit is at least partially recirculated to the drive unit, namely as a component of the fresh gas. The fuel and the fresh gas supplied to the drive unit form a fuel/fresh gas mixture with a certain composition, which is reacted in the drive unit.

During operation of the drive unit, exhaust gas is produced due to the chemical reaction of fuel and fresh gas with one another, which exhaust gas is discharged in the direction of an external environment of the drive device or of the motor vehicle. Preferably the exhaust gas is first fed to the exhaust gas aftertreatment device before being discharged into the environment, since pollutants are contained in the exhaust gas generated by the drive unit. In the exhaust gas aftertreatment device, the pollutants are at least partially converted into less dangerous products. Only after passing through the exhaust gas aftertreatment device is the exhaust gas discharged into the outside environment. The exhaust gas aftertreatment device is present, for example, as a vehicle catalytic converter, in particular as a three-way catalytic converter, oxidation catalytic converter, NOₓ storage catalytic converter or SCR catalytic converter. However, it can also be designed as a particulate filter, in particular as an Otto particulate filter or as a diesel particulate filter, preferably with an integrated vehicle catalytic converter, for example with a catalytic coating.

The drive device has the plurality of systems, each of which represents a part of the drive device. The systems are to be understood as meaning, for example, components of the drive device or of the drive unit, but also, additionally or alternatively, software programs which run on a control device of the drive device. The systems therefore comprise any desired elements of the drive device, in particular those which have an influence on a composition and/or a throughput of the exhaust gas. The throughput is to be understood here as an amount of the exhaust gas per unit time, in particular therefore an exhaust gas mass flow or an exhaust gas volume flow.

Purely by way of example, the systems of the drive device comprise one or more of the following systems: high-pressure fuel pump, fuel pressure sensor, load sensor, mixture adaptation, tank bleed valve, exhaust gas aftertreatment device, lambda probe, in particular pre-cat-lambda probe or post-cat-lambda probe, temperature sensor, ambient pressure sensor, charger, in particular compressor and/or exhaust turbocharger, charging pressure sensor, intake manifold leakage test, camshaft actuator, crankcase ventilation, EVAP system, in particular tank leakage test, expansion valve test or fuel tank shut-off valve test, cooling system, cylinder imbalance sensor, idling regulator, cold start strategy, valve stroke switching, exhaust flap, knock sensor and ignition detection.

For the systems of the drive device, the system diagnosis is carried out in each case, as part of which the state value is determined. The state value describes the state of the respective system and is determined for monitoring the individual system. Only one of the systems is considered in the system diagnosis, and a separate system diagnosis is carried out for each of the systems accordingly. Such a procedure is usually referred to as on-board diagnosis (OBD). It can already provide an indication of a possible system defect in individual systems.

Furthermore, the exhaust gas value describing the composition of the exhaust gas is determined by means of the exhaust gas probe. The exhaust gas value thus provides, in particular, an indication of the concentration of at least one exhaust gas component of the exhaust gas. The exhaust gas probe can be provided and arranged, for example, for measuring raw emissions of the drive unit or for measuring tailpipe emissions. In the former case, it is fluidically arranged between the drive unit and the exhaust gas aftertreatment device, in the latter case downstream of the exhaust gas aftertreatment device, i.e. fluidically between the exhaust gas aftertreatment device and an end pipe via which the exhaust gas is discharged into the external environment. The emissions of the drive unit can be monitored based on the exhaust gas value. For example, if an exhaust gas threshold value is exceeded, the exhaust gas value indicates a device defect in the drive device.

However, the exhaust gas value determined using the exhaust gas probe is primarily used to detect the system defect of one of the systems, in particular a system defect of the system that caused the exhaust gas value to exceed the exhaust gas threshold value. This indicates in particular a potential system defect of one of the systems without a large number of systems having to be checked first, for example, as part of a repair of the drive device. This process can also be referred to as “pinpointing”.

Of course, only a single exhaust gas value can be used. Preferably, however, multiple exhaust gas values are used, which are present in particular for multiple different exhaust gas components. In this respect, it is provided to determine at least one exhaust gas value by means of at least one exhaust gas probe. Further preferably, one of multiple exhaust gas value ranges is assigned to each of these exhaust gas values. The procedure described for the system defect data sets is carried out, for example, if one or more of the exhaust gas values leave their respectively assigned exhaust gas value range.

The diagnosis of the multiple systems as a whole is carried out as part of a device diagnosis. In contrast to the system diagnosis, this does not only consider a single system, but rather multiple systems. The device diagnosis provides feedback as a result as to which of the systems has the system defect or at least for which of the systems this is the case with a certain probability. In order to carry out the device diagnosis, it is stored for each of the systems whether the system defect of the respective system affects the exhaust gas value, in particular in a data memory. For example, a flag is stored in the data memory for each of the systems, which has a first state if the system defect of the respective system affects the exhaust gas value and a second value if this is not the case. The system defect data sets are used for this purpose. At least one system data set is stored for each of the systems. However, it may also be provided that multiple system data sets are stored for one or more of the systems, each of which sets describes different types of system defect.

If the exhaust gas value now leaves the exhaust gas value range, i.e. is outside the exhaust gas value range, the device diagnosis is carried out, in particular only in this case. As part of the device diagnosis, all system defect data sets or at least some of the system defect data sets are first placed on the checklist, which indicates or lists the system defect data sets to be checked. Subsequently, all those system defect data sets are removed from the checklist for which no influence on the exhaust gas value is stored, i.e. whose system is not responsible for leaving the exhaust gas value range by the exhaust gas value range, or is at most unlikely to be so. Thus, those system defect data sets remain on the checklist whose systems have potentially caused the deviation of the exhaust gas value from the exhaust gas value range.

At this point, it should be noted that, within the scope of this description, the systems, the system data sets and the system defects are partially referred to in the plural. It goes without saying that any desired number of systems, system data sets and system defects can always be present, i.e. also no system, no system data set and no system defect or only one system, only one system data set and only one system defect. This is especially true when it is said that system data sets should be removed from the checklist. In this case, no system data set, only one system data set or multiple system data sets can be removed from the checklist, depending on whether the respective condition applies.

After the checklist is provided, the system defect data sets remaining on the checklist are further checked against the state value assigned to their respective system as part of the device diagnosis in order to determine the potential system defect. The state value is used to determine the probability with which the respective system caused the deviation of the exhaust gas value from the exhaust gas value range. In other words, the device diagnosis of the corresponding system is performed for each of the remaining system defect data sets. It should be noted that the state values of the systems used during the device diagnosis correspond to the state values determined as part of the system diagnosis. The state values are therefore not newly determined for the device diagnosis, but the values previously determined for the system diagnoses are used.

Preferably, thereafter, i.e. at the end of the device diagnosis or after the device diagnosis, for one of the system data sets remaining on the checklist or for the system assigned to it the system defect is detected on the basis of its respective state value. For example, this takes place for the system whose state value has exceeded a state threshold value assigned to the system or is closest to this.

In the described manner, the system which is the cause of the deviation of the exhaust gas value from the exhaust gas value range can be identified with high reliability. Accordingly, as part of the maintenance of the drive device or the motor vehicle, replacement of the system can be initiated or carried out without further diagnostic effort.

Optionally, it is also provided that the system defect data sets removed from the checklist are written to a checked list. For example, the checked list is emptied beforehand. If the checklist is completely empty after removal of the system defect data sets, i.e. if no system defect data set is contained in it, the system defect data set for whose system the worst, i.e. usually the largest, state value is stored is preferably selected from the checked list. The system error is detected for this system.

This is preferably the case only if the state value has additionally exceeded a threshold value assigned to the system. This threshold value is preferably selected to be smaller than the state threshold value, the exceeding of which is already detected solely on the basis of the system defect. In order to detect the system defect, it is therefore necessary first for the exhaust gas value to leave the exhaust gas value range, for the checklist to be empty or for all system defect data sets to be removed from it and, in addition, for the state value of the system which has the worst state value to exceed the threshold value. The described procedure is preferably used after carrying out the device diagnosis.

A further development of the invention provides that, for each of the plurality of system defect data sets, the direction in which the system defect of the respective system affects the exhaust gas value is stored in each case, and, when the exhaust gas value leaves the exhaust gas value range in a certain direction, those system defect data sets for which no influence on the exhaust gas value in the certain direction is stored are removed from the checklist. In addition to the information as to whether the system defect of the respective system affects the exhaust gas value at all, the information as to the direction in which the exhaust gas value changes due to the system defect is also stored. Consequently, by changing the exhaust gas value in the specific direction or it leaving the exhaust gas value range in this direction, it is possible to determine with even greater accuracy which system is the cause of this.

For this purpose, if the exhaust gas value is outside the exhaust gas value range, it is determined in which direction the exhaust gas value has left the exhaust gas value range, i.e. for example whether the exhaust gas value is less than a lower limit of the exhaust gas value range or greater than an upper limit of the exhaust gas value range. Depending on the direction in which the exhaust gas value lies outside the exhaust gas value range, those system defect data sets are removed from the checklist for which no influence on the exhaust gas value is stored in this direction or for which only an influence in the respectively opposite direction is stored. This further improves the accuracy of the described method.

A further development of the invention provides that for at least one of the systems multiple system defect data sets are stored for different types of system defect and their influence on the exhaust gas value. It is possible that different changes in the exhaust gas value occur with different types of system defect or different system defects of the system. If, for example, the high-pressure fuel pump supplies too high a pressure, this will have a different effect on the exhaust gas value than if it supplies too low a pressure. Depending on the exhaust gas component for which the exhaust gas value is determined, for example, the excessively high pressure causes a change in the exhaust gas value, while the excessively low pressure has no or at most significantly lower effects on the exhaust gas value. Accuracy can therefore be further improved by storing the different types of system defect and their respective influence on the exhaust gas value. The system is preferably stored multiple times in the checklist, namely for each of the different types of system defect. This is done in the form of the multiple system defect data sets for the system.

A further development of the invention provides that the exhaust gas value is one of a plurality of exhaust gas values which are determined for different exhaust gas components and/or for different operating states of the drive device and/or for different configurations of the drive unit. Thus, not only is there a single exhaust gas value, but multiple exhaust gas values are used to carry out the device diagnosis. In particular, the device diagnosis is carried out when one of the plurality of exhaust gas values leaves its respectively assigned exhaust gas value range, i.e. lies outside this. The exhaust gas values are available for different exhaust gas components, for example. They can be determined using different exhaust gas probes. However, they are preferably determined using the same exhaust gas probe, namely in particular by utilizing a cross-sensitivity of the exhaust gas probe. For example, the exhaust gas probe is a NOₓ probe which has NH₃ cross-sensitivity. With the aid of the exhaust gas probe, an exhaust gas value for NOₓ and an exhaust gas value for NH₃ can be determined.

In addition or alternatively, the multiple exhaust gas values are determined for different operating states of the drive device. One of the exhaust gas values is thus determined for a first operating state and another of the exhaust gas values is determined for a second operating state different from the first operating state. The first operating state is, for example, a warm-up operating state and the second operating state is a normal operating state. The warm-up operating state is preferably present as long as at least one of the following conditions is met: the exhaust gas aftertreatment device is heated, a temperature of the exhaust gas aftertreatment device is less than a temperature threshold value, an air mass flowing through the exhaust gas aftertreatment device since the start of operation of the drive device is less than an air mass threshold value and a heat quantity introduced into the exhaust gas aftertreatment device since the start of operation is less than a heat quantity threshold value. For example, the warm-up state is present as long as at least one of the stated conditions is met. However, it may also be provided that multiple or all of the stated conditions must be met. If the conditions or the conditions for the warm-up state are no longer met, the normal operating state is present.

In addition or alternatively, different configurations of the drive device or of the drive unit may be stored for at least one of the systems. If the drive unit has multiple cylinder banks, for example, the system defects for each of the cylinder banks may be stored and accordingly their respective influence on the exhaust gas value. For this purpose, multiple system defect data sets are stored for the affected system(s).

In the event that exhaust gas values are used for two different exhaust gas components and for two different operating states of the drive device, a total of four exhaust gas values are available. These are for the above examples: a first exhaust gas value for NOₓ during the warm-up operating state, a second exhaust gas value for NOₓ during the normal operating state, a third exhaust gas value for NH₃ during the warm-up operating state and a fourth exhaust gas value for NH₃ during the normal operating state. For each of these exhaust gas values, a separate exhaust gas value range is defined, upon leaving which the device diagnosis is carried out. In addition, it is stored for each of the exhaust gas values for each of the system defect data sets whether the system defect of the respective system affects the respective exhaust gas value. The described procedure enables particularly detailed device diagnosis.

A further development of the invention provides that an exhaust gas measured value is measured by means of the exhaust gas probe and the exhaust gas value is determined from the exhaust gas measured value by accumulating over a distance traveled by the vehicle and normalizing by means of the distance traveled and/or by normalizing by means of a model value determined using an exhaust gas model. The exhaust gas value is therefore not measured directly by means of the exhaust gas probe, but is determined from the measured exhaust gas measured value. This at least partially eliminates influences that are due, for example, to different distances traveled and/or different driving styles.

To determine the exhaust gas value, the exhaust gas measured value is first accumulated, i.e. summed up or integrated, in particular since the start of driving of the motor vehicle. The start of driving is to be understood in particular as a start of the drive device or the drive unit after a previous parking of the motor vehicle. The accumulated exhaust gas value is then normalized by means of the distance traveled since the start of the journey, so that the exhaust gas value is finally specified as mass or weight per unit distance, for example as grams per kilometer.

In addition or alternatively, the exhaust gas value is determined from the exhaust gas measured value by normalizing using the model value. The model value is the result of the exhaust gas model, which is used to calculate the theoretical exhaust gas value. For example, the exhaust gas model uses at least one operating variable of the drive device or of the drive unit as an input variable, for example an operating point of the drive unit, which describes the drive torque currently provided by the drive unit and/or the instantaneous speed of the drive unit. The model value provided by the exhaust model as an output describes the composition of the exhaust gas in the event that all systems are fully functional. For example, the exhaust model assumes that all systems are in a new state.

Particularly preferably, the exhaust gas value results from the exhaust gas measured value by accumulating over the distance traveled by the vehicle and normalizing both by means of the distance traveled and by means of the model value. Consequently, the exhaust gas value does not directly describe the composition of the exhaust gas, but only indirectly, namely by describing the deviations of the composition of the exhaust gas from a modeled composition of the exhaust gas. The described procedure largely eliminates influences that are due to uncontrollable boundary conditions, for example, driver handling, and thus enables reliable device diagnosis.

A further development of the invention provides that the measurement of the exhaust gas measured value is carried out continuously, in particular over a driving cycle of the motor vehicle. The exhaust gas measured value is measured here, for example, at short time intervals, i.e. multiple times during the driving cycle. The driving cycle extends from the start of driving to the end of driving the motor vehicle. However, the exhaust gas value for the driving cycle is particularly preferably calculated only once, for example at the start of the driving cycle or at the end of the driving cycle. In this respect, the exhaust gas value is only determined once for each of the driving cycles in the event of multiple driving cycles. This enables reliable execution of the device diagnosis.

A further development of the invention provides that, at least for the system defect data sets remaining on the checklist, the state value of the respective system is normalized by means of a state threshold value, the state value of which is detected independently of the exhaust gas measured value for the system defect of the respective system when the state value exceeds it. It has already been explained above that the respective state value is determined for each of the systems. This applies at least to those systems for which system defect data sets remain on the checklist, but can of course be provided for all systems. The state threshold value is also defined for each of the systems. If the state value exceeds the state threshold value, the system defect of the respective system is detected independently of the exhaust gas measured value. Such a procedure is provided in particular as part of the system diagnosis, i.e. in the diagnosis of the individual systems. This procedure can also be referred to as on-board diagnosis.

As part of the device diagnosis, the state threshold value is preferably used for normalizing the state value. The normalized state value is therefore present as a state value divided by the state threshold value. The normalized state value enables a statement about the state of the respective system. As part of the device diagnosis, the normalized state value is preferably always used instead of the state value, even if this is not indicated separately. The described procedure enables a further improvement in the accuracy of the device diagnosis.

A further development of the invention provides that at least one of the following diagnostic types is carried out for the system defect data sets remaining on the checklist as part of the device diagnosis: correlation diagnosis, link diagnosis, statistical diagnosis and intrusive diagnosis. Usually, multiple system defect data sets remain on the checklist after the exhaust gas value has been evaluated. In order to thin out the checklist further and thus finally be able to make a plausible statement about the system defect of one of the systems, at least one of the diagnostic types mentioned is carried out before, for example, the system defect of the system is detected on the basis of the system defect data sets still remaining on the checklist using the state value of the respective system. It may be provided that only a single one of the above-mentioned diagnostic types is performed. Preferably, however, multiple diagnostic types, in particular all diagnostic types, are used for the system defect data sets remaining on the checklist. The diagnostic types are preferably used in the specified sequence, but a different sequence is also possible in principle. The use of the at least one type of diagnosis enables a reliable statement about the system defect of the one system.

A further development of the invention provides that, as part of the correlation diagnosis, at least the system defect data sets remaining on the checklist are carried out for the presence of a time correlation between a time profile of the exhaust gas value and a time profile of the state value for the respective system, wherein, when the correlation is present for at least one of the system defect data sets, all system defect data sets for which the correlation is not determined are removed from the checklist. The correlation diagnosis is used to correlate the time profile of the exhaust gas value with the time profiles of the state values of those systems for which at least one system defect data set remains on the checklist. Finally, therefore, a correlation measure is assigned to each of the system defect data sets or at least to the system defect data sets still remaining on the checklist, which reflects the extent of a dependency between the time profile of the exhaust gas value and the time profile of the state value for the respective system. The correlation measure is present, for example, in the form of a correlation coefficient.

If it is determined as part of the correlation diagnosis that a change in the time profile of the exhaust gas value coincides with a change in the time profile of the state value for at least one of the system defect data sets, it is assumed that the change in the time profile of the exhaust gas value was caused by the respective system. Consequently, only all those system defect data sets for which such a correlation is determined, i.e. the correlation measure or the correlation coefficient exceeds a certain threshold value, are left on the checklist. Those system defect data sets for which the correlation is not determined, i.e. the correlation measure or the correlation coefficient is smaller or equal to the threshold value, are removed from the checklist. Removal from the checklist is particularly preferred only if the correlation is present at all for one of the system defect data sets. This procedure can usually be used to significantly reduce the number of system defect data sets remaining on the checklist so that the system defect can be detected efficiently.

A further development of the invention provides that a linking condition is stored for at least a first one of the system defect data sets of a first one of the systems, which link condition has a relationship between a first state value change of the state value and a second state value change of the state value assigned to a second system, wherein, as part of the linking diagnosis, those system defect data sets are removed from the checklist for which the respective linking condition is not fulfilled. The link diagnosis uses physical relationships to link the individual system defect data sets with each other. The underlying observation here is that a first system of the first system defect data set and a second system of the second system defect data set are physically connected to one another, so that when the state value of the first system changes, there must also be a change in the state value of the second system, or vice versa. This link is formulated by means of the linking condition, which connects the two system defect data sets with each other. The change in the state value of the first system is also referred to as the first state value change and the change in the state value of the second system is also referred to as the second state value change.

The linking condition can be, for example, one of the following conditions: both the first state value change and the second state value change are different from zero, both the first state value change and the second state value change are different from zero and have the same sign, both the first state value change and the second state value change are different from zero and have the same amount within a certain tolerance.

For example, a linking condition to each of the other system defect data sets is formulated for each of the system defect data sets. Purely by way of example, the first system defect data set concerns the load sensor and the second system defect data set concerns mixture adaptation. A defect in the load sensor inevitably also influences the mixture adaptation, so that a change in the state value of the load sensor also results in a change in the state value of the mixture adaptation. The described procedure enables the system defect data sets to be efficiently eliminated from the checklist.

A further development of the invention provides that, as part of the statistical diagnosis, a scatter of the time profile of the state value for the respective system is determined at least for the system defect data sets remaining on the checklist and those system defect data sets for which the scatter is greater are removed from the checklist. The background to the statistical diagnosis is the check of the state values for their accuracy. It is assumed here that state values for which the time profile shows a smaller fluctuation or a smaller scattering are more reliable than those for which the fluctuation or scatter is greater. For example, for each of the system defect data sets, a standard deviation is calculated over the time profile of the state value for the respective system.

It may be provided to remove from the checklist all system defect data sets for which the standard deviation exceeds a certain threshold value. In addition or alternatively, only the system defect data set for which the standard deviation is the smallest is retained, in particular only if a difference between the standard deviation of this system defect data set and the standard deviation of the system defect data set with the next smaller standard deviation is greater than a further threshold value. The statistical validity of the state values is checked with the aid of the statistical diagnosis. This ensures that the device diagnosis is carried out effectively.

A further development of the invention provides that, as part of the intrusive diagnosis, a fourth system defect data set is selected for a third of the system defect data sets at least from the system defect data sets remaining on the checklist, for the associated system of which a change in an operating state of the drive unit causes a different, in particular opposing, change in the exhaust gas value and/or the state value as for the system of the third system defect data set, wherein after the change has been made, that one of the system defect data sets for which the change in the exhaust gas value and/or the state value does not occur is removed from the checklist. The intrusive diagnosis comprises an active intervention in the operation of the drive unit, namely the change in the operating state. For example, the change in the operating state includes a change in the composition of the fuel/fresh gas mixture, a change in the provided drive torque and/or a change in the speed of the drive unit.

System defect data sets which react differently to the change in operating state, in particular in the opposite way, are selected as the third system defect data set and fourth system defect data set. The change in the operating state is then implemented. The exhaust gas value and/or the state values of the systems assigned to the system defect data sets are then evaluated. If the stored change in the exhaust gas value or the stored change in the state value does not occur for one or more system defect data sets, these are removed from the checklist. This effectively eliminates further system defect data sets. Particularly preferably, intrusive diagnosis is only permitted and carried out if the exhaust gas measured value exceeds a certain threshold value. In this case, a defect message is usually already generated, in particular the MIL (malfunction indicator lamp) is activated.

A further development of the invention provides that, using an exhaust gas component model, an exhaust gas component concentration of at least one exhaust gas component of the exhaust gas is determined and corrected by means of a correction factor determined from the exhaust gas value, wherein if an exhaust gas component threshold value is exceeded by the exhaust gas component concentration the device defect of the drive device is detected. The exhaust gas component model is used to determine the exhaust gas component concentration, in particular in terms of flow between the drive unit and the exhaust gas aftertreatment device. The exhaust gas component model assumes that all systems of the drive unit are fully functional, in particular as-new.

The correction factor should be used to take into account the actual state of the systems, in particular for an exhaust gas component or for exhaust gas components for which no measured value from a sensor is available. For this purpose, the exhaust gas value is used to determine the correction factor. The correction factor is then used to correct the exhaust gas component concentration, for example by multiplication. If the corrected exhaust gas component concentration exceeds the exhaust gas component threshold value, it is assumed that the exhaust gas emissions of the drive device are no longer in the permissible range and the device defect of the drive device is detected accordingly. This achieves reliable operation of the drive device within the intended specification.

In other words, the exhaust gas component concentration of the at least one exhaust gas component of the exhaust gas is first determined using the exhaust gas component model, namely for a defect-free drive device in which all systems operate defect-free, in particular are as good as new. The exhaust gas component concentration is then corrected using the correction factor. The correction factor is therefore used to describe an exhaust gas component concentration of an exhaust gas component for which no measured value is available.

The invention also relates to a drive device for a motor vehicle, in particular for executing the method according to the statements within the scope of the present description, wherein the drive device has an exhaust-gas-generating drive unit, and is provided and designed to determine, by means of an exhaust gas probe an exhaust gas value describing a composition of the exhaust gas, and to determine, for a plurality of systems of the drive device, a state value describing the state of the respective system, in each case as part of a system diagnosis.

In particular, it is provided that for each of the plurality of systems, it is defined in at least one system defect data set whether a system defect of the respective system affects the exhaust gas value, wherein the drive device is further provided and designed to put, if the exhaust gas value departs from an exhaust gas range, the system defect data sets of the systems first on a checklist of system defect data sets to be checked, and then to remove those system defect data sets for which it is defined that the exhaust gas value is not affected, from the checklist, wherein for the system defect data sets remaining on the checklist, a device diagnosis is carried out to detect the system defect of the respective system based on the state value.

The advantages of such a configuration of the drive device and of such a procedure have already been discussed. Both the drive device and the method for its operation can be refined according to the statements within the scope of this description, to which reference will therefore be made.

The features and feature combinations described in the description, in particular the features and feature combinations described below in the description of the figures and/or shown in the figures may be used not only in the respective specified combination, but also in other combinations or alone, without departing from the scope of the invention. The invention should therefore also be considered to comprise embodiments that are explicitly not shown or explained in the description and/or the figures, but emerge from the explained embodiments or can be derived from them.

### BRIEF DESCRIPTION OF THE FIGURE

In the following, the invention will be explained in greater detail with reference to the exemplary embodiments depicted in the drawings, without this restricting the invention. In particular, the only

FIG. 1 is a schematic representation of a method for operating a drive device for a motor vehicle.

### DETAILED DESCRIPTION

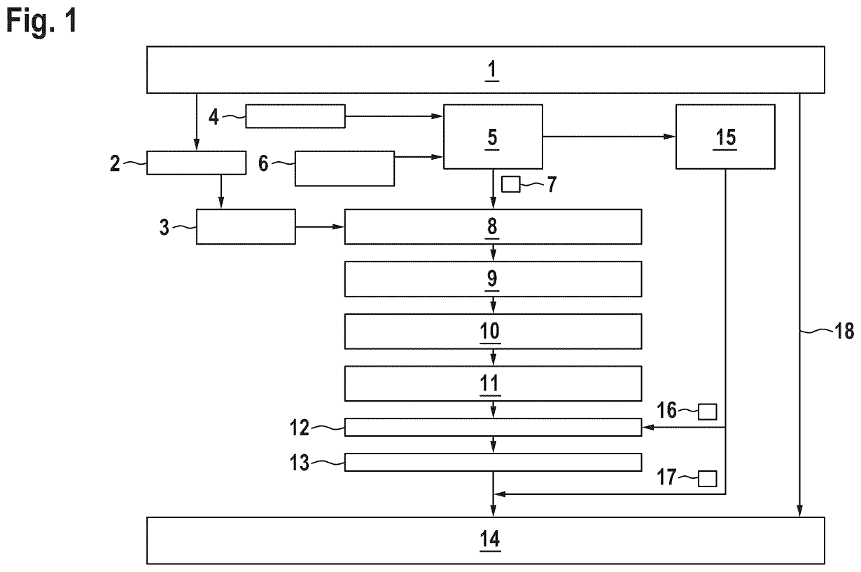

FIG. 1 shows a schematic representation of a method for operating a drive device for a motor vehicle. The drive device has a drive unit that generates exhaust gas and an exhaust gas probe, by means of which an exhaust gas value is determined that describes a composition of the exhaust gas of the drive unit. In a module 1 of the method, a state value describing a state of the respective system is to be determined for multiple systems of the drive device as part of a system diagnosis. The state values obtained in this case are normalized within the framework of a module 2, namely using a state threshold value assigned to the respective system.

In addition, multiple system defect data sets are stored in a module 3, which are assigned to the systems. At least one of the system defect data sets is assigned to each of the systems. It may also be provided that at least one of the systems has multiple system defect data sets assigned to it. In a module 4, an exhaust gas measured value is determined with the aid of the exhaust gas probe and transmitted to a module 5. The module 5 has a model value as a further input value, which is determined in a module 6. The model value is determined using an exhaust gas model and describes the composition of the exhaust gas with a fully functional drive device. In module 5, an exhaust gas value is determined from the exhaust gas measured value and the model value, which exhaust gas value is present in a normalized form to this extent, i.e. can also be referred to as a normalized exhaust gas value.

In a module 7, a deviation of the exhaust gas value from an exhaust gas value range is checked. If the deviation is present, all those system defect data sets for which no influence on the exhaust gas value is stored are removed from the checklist in a module 8. Subsequently, multiple different diagnoses are performed as part of a device diagnosis, which are performed in the modules 9, 10, 11 and 12. A correlation diagnosis is performed in the module 9, a link diagnosis is performed in the module 10, a statistical diagnosis is performed in the module 11 and an intrusive diagnosis is performed in the module 12. As part of each of the diagnoses, as many of the system data sets as possible are removed from the checklist.

If multiple system defect data sets then remain on the checklist, the system defect data set for whose assigned system the largest state value is present is selected in a module 13. A system defect is then detected in a module 14 for the system of the remaining system defect data set. Furthermore, it is preferably provided that, when a threshold value is exceeded by the exhaust gas value or the exhaust gas measured value, a device defect of the drive device is detected directly in a module 15. It may also be provided that the intrusive diagnosis is only enabled in this case by means of a module 16. In addition or alternatively, it may be provided that the evaluation of the remaining system defect data set is enabled and otherwise prevented by means of a module 17 only in this case.

Finally, it may be provided to compare the state values of the plurality of systems directly with a state threshold value assigned to the respective system. If the state value exceeds the state threshold value, the system defect of the respective system is detected directly. This is indicated by arrow 18. The procedure described is used to efficiently signal the system for which the system defect is present. Complex troubleshooting or system diagnostics of the other systems can therefore be omitted.

### LIST OF REFERENCE NUMERALS

1 module
2 module
3 module
4 module
5 module
6 module
7 module
8 module
9 module
10 module
11 module
12 module
13 module
14 module
15 module
16 module
17 module
18 arrow

1-10. (canceled)

11. A method for operating a drive device for a motor vehicle, wherein the drive device has an exhaust-gas-generating drive unit, and by an exhaust gas probe an exhaust gas value describing a composition of the exhaust gas is determined, and for a plurality of systems of the drive device a state value describing the state of the respective system is determined, in each case as part of a system diagnosis, wherein, for each of the plurality of systems, it is defined in at least one system defect data set whether a system defect of the respective system affects the exhaust gas value, wherein if the exhaust gas value departs from an exhaust gas range, the system defect data sets of the systems are first put on a checklist of system defect data sets to be checked, and then, those system defect data sets for which it is defined that the exhaust gas value is not affected are removed from the checklist, wherein for the system defect data sets remaining on the checklist, a device diagnosis is carried out to detect the system defect of the respective system based on the state value.

12. The method according to claim 11, wherein, for each of the plurality of system defect data sets, the direction in which the system defect of the respective system affects the exhaust gas value is stored in each case, and, when the exhaust gas value leaves the exhaust gas value range in a certain direction, those system defect data sets for which no influence on the exhaust gas value in the certain direction is stored are removed from the checklist.

13. The method according to claim 11, wherein the exhaust gas value is one of a plurality of exhaust gas values which are determined for different exhaust gas components and/or for different operating states of the drive device and/or for different configurations of the drive unit.

14. The method according to claim 11, wherein an exhaust gas measured value is measured by the exhaust gas probe and the exhaust gas value is determined from the exhaust gas measured value by accumulating over a distance traveled by the vehicle and normalizing by the distance traveled and/or by normalizing by a model value determined using an exhaust gas model.

15. The method according to claim 11, wherein at least one of the following diagnostic types is carried out for the system defect data sets remaining on the checklist as part of the device diagnosis: correlation diagnosis, link diagnosis, statistical diagnosis and intrusive diagnosis.

16. The method according to claim 11, wherein, as part of the correlation diagnosis, at least the system defect data sets remaining on the checklist are carried out for the presence of a time correlation between a time profile of the exhaust gas value and a time profile of the state value for the respective system, wherein, when the correlation is present for at least one of the system defect data sets, all system defect data sets for which the correlation is not determined are removed from the checklist.

17. The method according to claim 11, wherein a linking condition is stored for at least a first one of the system defect data sets of a first one of the systems, which link condition has a relationship between a first state value change of the state value and a second state value change of the state value assigned to a second system, wherein, as part of the linking diagnosis, those system defect data sets are removed from the checklist for which the respective linking condition is not fulfilled.

18. The method according to claim 11, wherein, as part of the statistical diagnosis, a scatter of the time profile of the state value for the respective system is determined at least for the system defect data sets remaining on the checklist and those system defect data sets for which the scatter is greater are removed from the checklist.

19. The method according to claim 11, wherein, as part of the intrusive diagnosis, a fourth system defect data set is selected for a third of the system defect data sets at least from the system defect data sets remaining on the checklist, for the associated system of which a change in an operating state of the drive unit causes a different, in particular opposing, change in the state value as for the system of the third system defect data set, wherein after the change has been made, that one of the system defect data sets for which the change in the state value does not occur is removed from the checklist.

20. A drive device for a motor vehicle, in particular for executing the method according to one or more of the preceding claims, wherein the drive device has an exhaust-gas-generating drive unit, and is provided and designed to determine, by an exhaust gas probe, an exhaust gas value describing a composition of the exhaust gas, and to determine, for a plurality of systems of the drive device, a state value describing the state of the respective system, in each case as part of a system diagnosis, wherein, for each of the plurality of systems, it is defined in at least one system defect data set whether a system defect of the respective system affects the exhaust gas value, wherein the drive device is further provided and designed to put, if the exhaust gas value departs from an exhaust gas range, the system defect data sets of the systems firstly on a checklist of system defect data sets to be checked, and then to remove those system defect data sets for which it is defined that the exhaust gas value is not affected from the checklist, wherein for the system defect data sets remaining on the checklist, a device diagnosis is carried out to detect the system defect of the respective system based on the state value.

21. The method according to claim 12, wherein the exhaust gas value is one of a plurality of exhaust gas values which are determined for different exhaust gas components and/or for different operating states of the drive device and/or for different configurations of the drive unit.

22. The method according to claim 12, wherein an exhaust gas measured value is measured by the exhaust gas probe and the exhaust gas value is determined from the exhaust gas measured value by accumulating over a distance traveled by the vehicle and normalizing by the distance traveled and/or by normalizing by a model value determined using an exhaust gas model.

23. The method according to claim 13, wherein an exhaust gas measured value is measured by the exhaust gas probe and the exhaust gas value is determined from the exhaust gas measured value by accumulating over a distance traveled by the vehicle and normalizing by the distance traveled and/or by normalizing a model value determined using an exhaust gas model.

24. The method according to claim 12, wherein at least one of the following diagnostic types is carried out for the system defect data sets remaining on the checklist as part of the device diagnosis: correlation diagnosis, link diagnosis, statistical diagnosis and intrusive diagnosis.

25. The method according to claim 13, wherein at least one of the following diagnostic types is carried out for the system defect data sets remaining on the checklist as part of the device diagnosis: correlation diagnosis, link diagnosis, statistical diagnosis and intrusive diagnosis.

26. The method according to claim 14, wherein at least one of the following diagnostic types is carried out for the system defect data sets remaining on the checklist as part of the device diagnosis: correlation diagnosis, link diagnosis, statistical diagnosis and intrusive diagnosis.

27. The method according to claim 12, wherein, as part of the correlation diagnosis, at least the system defect data sets remaining on the checklist are carried out for the presence of a time correlation between a time profile of the exhaust gas value and a time profile of the state value for the respective system, wherein, when the correlation is present for at least one of the system defect data sets, all system defect data sets for which the correlation is not determined are removed from the checklist.

28. The method according to claim 13, wherein, as part of the correlation diagnosis, at least the system defect data sets remaining on the checklist are carried out for the presence of a time correlation between a time profile of the exhaust gas value and a time profile of the state value for the respective system, wherein, when the correlation is present for at least one of the system defect data sets, all system defect data sets for which the correlation is not determined are removed from the checklist.

29. The method according to claim 14, wherein, as part of the correlation diagnosis, at least the system defect data sets remaining on the checklist are carried out for the presence of a time correlation between a time profile of the exhaust gas value and a time profile of the state value for the respective system, wherein, when the correlation is present for at least one of the system defect data sets, all system defect data sets for which the correlation is not determined are removed from the checklist.

30. The method according to claim 15, wherein, as part of the correlation diagnosis, at least the system defect data sets remaining on the checklist are carried out for the presence of a time correlation between a time profile of the exhaust gas value and a time profile of the state value for the respective system, wherein, when the correlation is present for at least one of the system defect data sets, all system defect data sets for which the correlation is not determined are removed from the checklist.
